(19) United States
(12) Patent Application Publication
(10) Pub. No.: US 2006/0044948 A1
(43) Pub. Date: Mar. 2, 2006

(54) Portable disk player

(75) Inventor: Chiaki Hashimoto, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/203,134

(22) Filed: Aug. 15, 2005

(30) Foreign Application Priority Data
Aug. 16, 2004 (JP) P. 2004-236782

(51) Int. Cl. G11B 19/00; G11B 20/00

(52) U.S. Cl. 369/29.02; 369/47.16

(57) ABSTRACT

A portable disk player capable of playing a disk while carrying, includes: a reproducing part for playing a disk; a battery for supplying power for each part; a main title detecting unit for detecting playing a main title recorded in the disk, wherein when a power-saving mode is set, the power is turned off at an end of playing the main title.

### BACKGROUND OF THE INVENTION

1. Field of the Invention

The present invention relates to a portable disk player that is for playing a disk and can be carried.

2. Description of the Related Art

In a portable disk player capable of playing a disk while carrying with a battery, it is necessary to save battery consumption. In JP-UM-A-64-24561, there is disclosed a disk player capable of saving battery consumption. In this disk player, power is turned off with the detection that there is no reproducing signal by inspecting the reproducing signal. Thereby wasteful power consumption can be prevented.

In a disk such as DVD, there are recorded plural titles comprised by a main title of a movie, etc. and by a bonus track such as a making scene thereof, and a setting screen for initializing a language, etc. Accordingly, a menu screen is displayed to start a next desired operation at the stop of playing the titles. According to the disk player disclosed in JP-UM-A-64-24561, therefore, power is not turned off with the output of reproducing signal even at the stop of each title, which does not make possible to save power consumption.

### SUMMARY OF THE INVENTION

An object of the invention is to provide a portable disk player capable of reducing power consumption reliably.

To achieve the above object, according to a first aspect of the invention, there is provided a portable disk player that is capable of playing a disk while carrying and that including: a reproducing part for playing a disk; a display part for displaying an image output from the reproducing part; and a battery for supplying power for each part; a main title detecting unit for detecting playing a main title by judging a title with a longest time recorded in the disk to be the main title; and a time setting unit for setting a time from an end of playing the main title to a time of turning off the power in a power-saving mode during driving by the battery.

According to the first aspect of the invention, information recorded in a disk is reproduced with driving by the battery while an image is displayed on the display part. In the disk, there are recorded a main title, a making scene thereof, etc. of a movie, etc. and a title with a longest time recorded in the disk is judged to be the main title by the main title detecting unit. The power-saving mode is set when the portable disk player is driven by the battery, and the power of the portable disk player is turned off after a predetermined time set by a user using the time setting unit from the end of playing the main title detected by the main title detecting unit. The power may be turned off by the time setting unit concurrently with the end of playing the main title.

According to a second aspect of the invention, there is provided a portable disk player capable of playing a disk while carrying, including: a reproducing part for playing a disk; a battery for supplying power for each part; a main title detecting unit for detecting playing a main title recorded in the disk, wherein when a power-saving mode is set, the power is turned off at an end of playing the main title.

According to the second aspect of the invention, information recorded in a disk is reproduced with driving by the battery. When the power-saving mode is set by user operation, by detection of battery attachment or the like, the power of the portable disk player is turned off at the end of playing the main title detected by the main title detecting unit. In addition, image data and audio data in movie and the like may be recorded, or only audio data in music and the like may be recorded.

According to a third aspect of the invention in the second aspect of the invention, the a portable disk player further includes a time setting unit for setting a time from the end of playing the main title to a time of turning off power in the power-saving mode. According to the third aspect of the invention, the power of the portable disk player is turned off after a predetermined time set by a user using the time setting unit from the end of playing the main title.

According to a fourth aspect of the invention in the second and the third aspect of the invention, in the portable disk player, the power-saving mode is set when driven by the battery.

According to a fifth aspect of the invention in the second to the fourth aspect of the invention, the main title detecting unit judges a title with a longest time recorded in the disk to be the main title.

According to a sixth aspect of the invention in the second to the fourth aspect of the invention, the main title detecting unit judges a title with a predetermined title number recorded in the disk to be the main title.

According to the invention, since there is provided the power-saving mode for turning off power even with existence of a reproducing signal at the end of playing the main title when the portable disk player is driven by the battery, it becomes possible to reduce power consumption thereof reliably.

Also according to the invention, provision of the time setting unit for setting a time from the end of playing the main title to a time of turning off power in the power-saving mode makes it possible to continue to use with user operation after the end of playing the main title and improves the usability of the portable disk player.

Also according to the invention, setting the power-saving mode when driven by the battery eliminates the need for switching to the power-saving mode and improves the usability of the portable disk player.

Also according to the invention, since the main title detecting unit judges a title with a longest time recorded in the disk to be the main title, the detection of playing the main title can be facilitated.

Also according to the invention, since the main title detecting unit judges a title with a predetermined title number recorded in the disk to be the main title, the detection of playing the main title can be facilitated.

### BRIEF DESCRIPTION OF THE DRAWINGS

These and other objects and advantages of this invention will become more fully apparent from the following detailed description taken with the accompanying drawings in which:

FIG. 1 is a block diagram showing a configuration of a portable disk player according to the first embodiment of the invention;

FIG. 2 is a flowchart showing an operation of the portable disk player according to the first embodiment of the invention;

FIG. 3 is a flowchart showing an operation of the portable disk player according to the second embodiment of the invention; and

FIG. 4 is a flowchart showing a timer clocking process of the portable disk player according to the second embodiment of the invention.

### DETAILED DESCRIPTION OF THE PREFERRED EMBODIMENTS

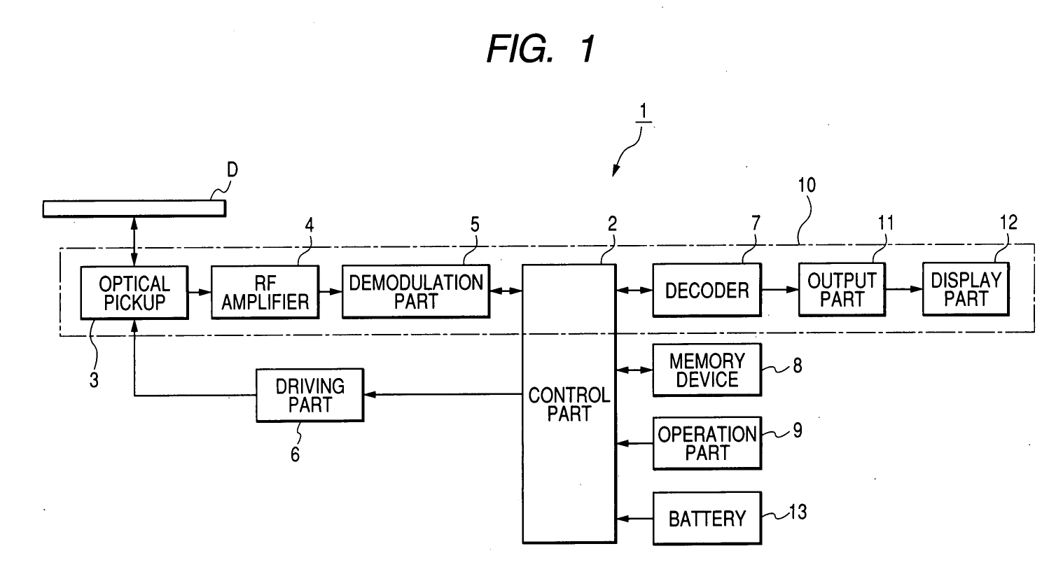

Hereafter, an embodiment of the invention will be described in reference to drawings. FIG. 1 is a block diagram showing a configuration of a portable disk player according to the first embodiment. A portable disk player 1 includes a control part 2 for controlling each part. To the control part 2, there are connected a demodulation part 5, a driving part 6, a decoder 7, a memory device 8, an operation part 9 and a battery 13.

The driving part 6 drives an optical pickup 3 for reading information written in a disk D. An RF amplifier 4 is connected to the optical pickup 3 while the demodulation part 5 is connected to the RF amplifier 4. The RF amplifier 4 amplifies a high-frequency detection signal detected in the optical pickup 3 and the demodulation part 5 demodulates data from the detection signal detected in the RF amplifier 4.

The decoder 7 connected to the control part 2 decodes the data demodulated by the demodulation part 5. An output part 11 is connected to the decoder 7 to output the decoded data. To the output part 11, a display part 12 and a speaker (not shown) are connected. Therefore, a reproducing part 10 for reproducing image data and audio data that are written in the disk D is configured by: the optical pickup 3; the RF amplifier 4; the demodulation part 5; the control part 2; the decoder 7; the output part 11; the display part 12; and the speaker.

The operation part 9 connected to the control part 2 is provided at a main part of the portable disk player 1 or a remote control (not shown) capable of communicating with the main part and gives various instructions to the control part 2 with user operation. The memory device 8 is configured by EEPROM, RAM and soon to store a program for driving the portable disk player 1 and store an operation result in the control part 2 temporarily.

The battery 13 is rechargeable, supplies power for each part through the control part 2 and can drive the portable disk player 1 while carrying. Also, a household power supply can be connected to drive the portable disk player 1.

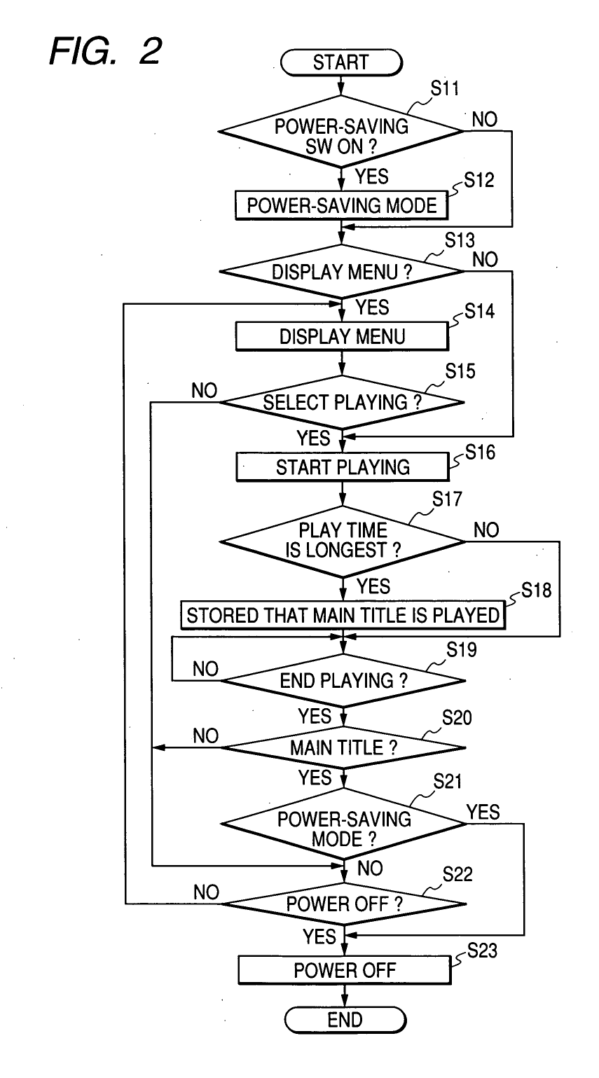

FIG. 2 is a flowchart showing an operation of the portable disk player 1. Turning on the power of the portable disk player 1, the program stored in the memory device 8 runs. In step S11, it is judged whether a power-saving switch provided in the operation part 9 is turned on or not. In the case of the power-saving switch turned off, there proceeds on to step S13.

In the case of the power-saving switch turned on, a power-saving mode is set in step S12. The power-saving mode, for example, saves power consumption by reducing the amount of light of the display part 12. The power-saving mode may be set in attaching the battery 13 after judging whether the battery 13 is attached or not in step S11, which eliminates the need for the power-saving switch operation and improves the usability of the portable disk player 1.

In step S13, it is judged whether a menu screen will be displayed or not. In the case of not displaying the menu screen in accordance with a setting written in the disk D, there proceeds on to step S16. In the case of displaying the menu screen, the menu screen is displayed on the display part 12 in step S14. In step S15, it is judged whether playing titles of a main title of a movie, etc. and a bonus track such as a making scene has been selected or not. In the case of playing either of the titles selected, there proceeds on to step S16.

In the case of not selecting playing either of the titles, it is judged whether turning off operation has been carried out or not in step S22. In the case of not carrying out the turning off operation, there goes back to step S14 and steps S14, S15 and S22 are repeated to be on standby for user operation. In addition, choice of language is displayed on the menu screen and when selecting one from the choice of language, setting language can be achieved.

In step S16, the selected title comprised by a main title of a movie, etc. or by a bonus track is played. In the case of not displaying the menu screen, the main title is automatically played. In step S17, it is judged whether the title now being played is a title with a longest time. In the case of not being a title with a longest time, there proceeds on to step S19. In the case of being a title with a longest time, there proceeds on to step S18.

In step S18, since a title with a longest time is normally a main title, it is stored in the memory device 8 that a main title is now being played. Thereby a main title detecting unit for detecting playing a main title is configured. In addition, since a title number of main title is normally recorded as “1” in the disk D, it may be judged that a main title is played in the case of the title number with a predetermined number such as “1”.

In step S19, the end of playing title is waited. At the end of playing title, it is judged whether the main title has been played or not in reference to the memory device 8 in step S20. In the case of not playing the main title, there proceeds on to step S22. In the case of playing the main title, it is judged whether the power-saving mode is set or not in step S21. In the case of not setting the power-saving mode, there proceeds on to step S22.

In step S22, it is judged whether the turning-off operation has been carried out or not. In the case of not having carried out the turning-off operation, there goes back to step S14 to display the menu screen. In the case of having carried out the turning-off operation, the power is turned off in step S23 and the whole process ends. In addition, in the case of power-saving mode according to the judgment in step S21, there proceeds on to step S23 to turn off the power immediately and the whole process ends.

According to this embodiment, since the power is turned off at the end of the main title in the power-saving mode even there is an output of reproducing signal for displaying the menu screen, the power consumption of the portable disk player can be reliably reduced.

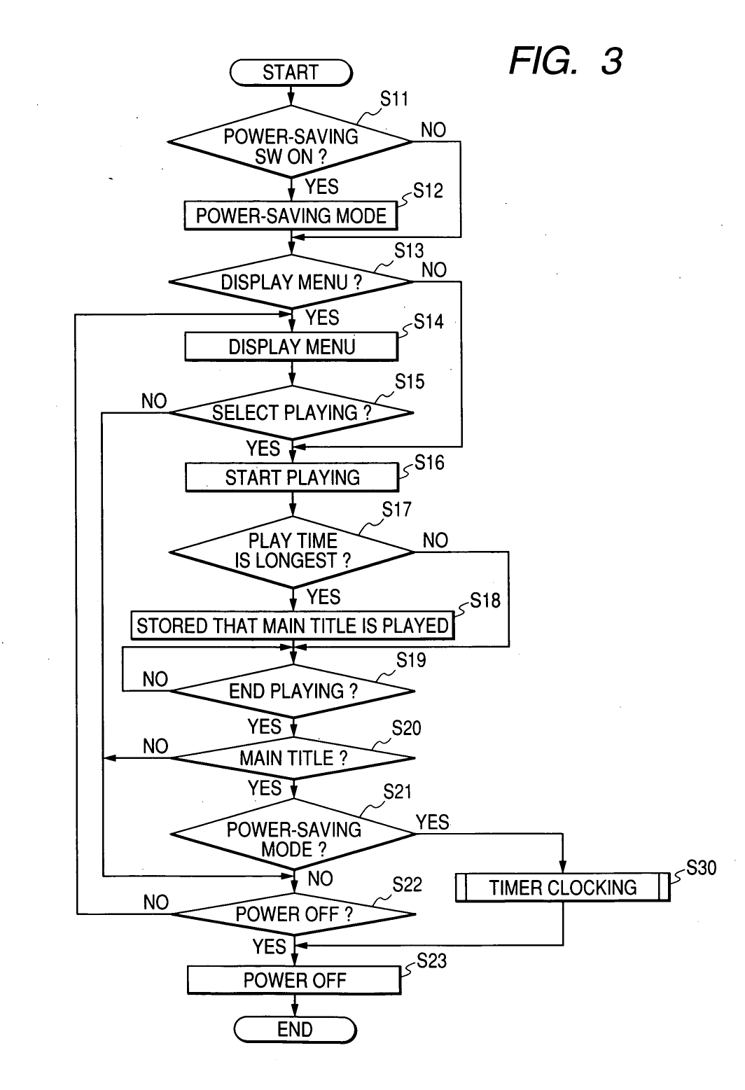

Next, FIG. 3 is a flowchart showing an operation of the portable disk player 1 according to the second embodiment. The portable disk player 1 in this embodiment is configured similarly to that in the first embodiment. In FIG. 3, timer clocking process is provided as step S30. Description of other components, which are the same as in the first embodiment, will be omitted.

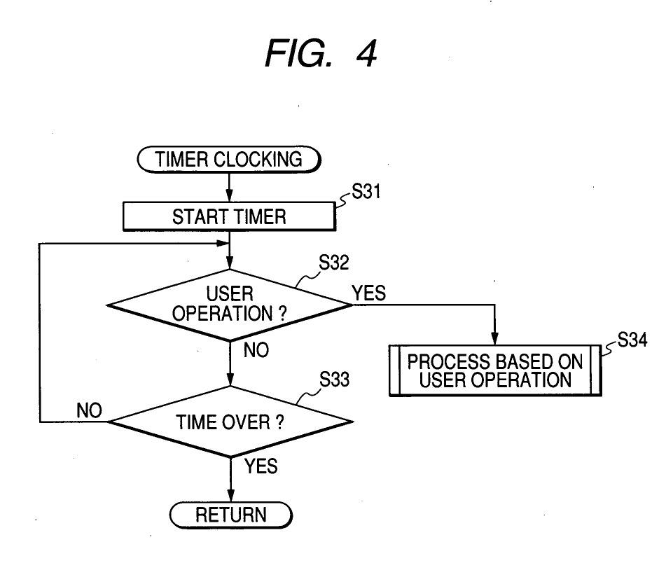

When it is judged the power-saving mode is set in step S21, there proceeds on to step S30 to call up the timer clocking process shown in FIG. 4. In the step S31 of timer clocking process, a timer provided in the control part 2 starts clocking immediately after the end of playing the main title. In step S32, it is judged whether the user operation by the operation part 9 has been carried out or not.

In the case of not having carried out the user operation, it is judged whether a predetermined time has passed or not after the start of timer clocking in step S33. This predetermined time has been set at, for example, 0 to 10 seconds by a user using a time setting unit operated by the control part 2. In the case of the predetermined time not having passed, there goes back to step S32 to be on standby until the predetermined time has passed while determining the existence of user operation.

When the user operation has been carried out before the predetermined time has passed, there proceeds on to step S34 to carry out a process based on the operation. When the predetermined time has passed without the user operation, there proceeds on to step S23 in FIG. 3 to turn off the power, and the whole process ends.

According to this embodiment, since it is possible to set the time from the end of playing the main title to turning off the power in the power-saving mode, it is possible to turn off the power immediately after the end of playing the main title and also possible to continue to use the portable disk player 1 with the user operation. Accordingly, the usability of the portable disk player 1 improves more. In addition, setting the predetermined time at 0 second allows the same operation as in the first embodiment.

Although the display part 12 is provided in the first and second embodiments, it is possible to employ a portable disk player in which an image can be seen through a separately-provided display device connected thereto. In addition, it is also possible to employ a portable disk player playing a disk D without image data recorded and outputting only audio data.

The invention can be employed to a disk player for playing such a disk with both image data and audio data recorded as DVD, Video-CD, HD DVD (registered trademark) and Blu-ray Disc, and such a disk with only audio data recorded as CD.

What is claimed is:

1. A portable disk player capable of playing a disk while carrying, comprising:
a reproducing part for playing a disk;
a display part for displaying an image output from the reproducing part;
a battery for supplying power for each part;
a main title detecting unit for detecting playing a main title by judging a title with a longest time recorded in the disk to be the main title; and
a time setting unit for setting a time from an end of playing the main title to a time of turning off the power in a power-saving mode during driving by the battery.

2. A portable disk player capable of playing a disk while carrying, comprising:
a reproducing part for playing a disk;
a battery for supplying power for each part;
a main title detecting unit for detecting playing a main title recorded in the disk, wherein
when a power-saving mode is set, the power is turned off at an end of playing the main title.

3. The portable disk player according to claim 2, further comprising
a time setting unit for setting a time from the end of playing the main title to a time of turning off power in the power-saving mode.

4. The portable disk player according to claim 2, wherein
the power-saving mode is set when driven by the battery.

5. The portable disk player according to claim 2, wherein
the main title detecting unit judges a title with a longest time recorded in the disk to be the main title.

6. The portable disk player according to claim 2, wherein
the main title detecting unit judges a title with a predetermined title number recorded in the disk to be the main title.
